(19) United States
(12) Patent Application Publication
(10) Pub. No.: US 2004/0188515 A1
(43) Pub. Date: Sep. 30, 2004

(54) Pre-paid internet credit card

(76) Inventor: Ivan Jimenez, Quito (EC)

Correspondence Address: Ray K. Shahani, Esq., ATTORNEY AT LAW, Twin Oaks Office Plaza, 477 Ninth Avenue, Suite 112, San Mateo, CA, 94402-1854, US

(21) Appl. No.: 10/402,761

(22) Filed: Mar. 26, 2003

(51) Int. Cl. G06K 5/00

(52) U.S. Cl. 235/380

(57) ABSTRACT

A card with different credit limits, in US dollars or currency of each country. The card has a bar code on the back that needs to be scratched, before using information that will show will be Pin or ID number, it will also show the name of the company, ID number, and the user can add customer name at the time of purchase (this is optional), expiration date, instructions on how to use the card to make purchases over the internet, if customer needs to add more credit limit to card he may do over the phone or on-line using a credit card or debit card . The cards will be sold at supermarkets, gas stations, pharmacies, train stations, airports, coffee shops. Material to create this card can be plastic, or any resistant material. Magnetic strip may be added by the company who sells the cards.

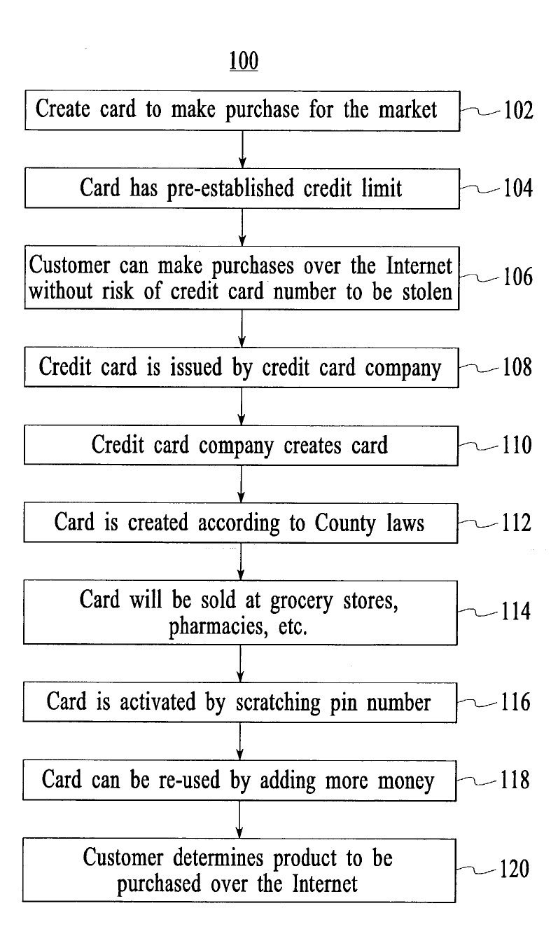

### FIELD OF THE INVENTION

The present invention is related to credit cards and phone cards, and in particular, to a pre-paid credit card which can be used to make secure transactions online and over the internet

### BACKGROUND OF THE INVENTION

The following patents are related to pre-paid phone cards, internet transactions, so-called “smart” (™) cards and card charging systems:

U.S. Pat. No. 5,883,810 issued Mar. 16, 1999 to Franklin et al.;

U.S. Pat. No. 5,987,140 to Rowney et al.;

U.S. Pat. No. 6,000,832 to Franklin et al;

U.S. Pat. No. 6,012,049 to Kawan;

U.S. Pat. No. 6,016,484 to Williams et al.;

U.S. Pat. No. 6,032,136 to Brake, Jr. et al.;

U.S. Pat. No. 6,119,946 to Teicher;

U.S. Pat. No. 6,169,975 to White et al.;

U.S. Pat. No. 6,182,900 to Wiehler;

U.S. Pat. No. 6,185,545 to Resnick et al.;

U.S. Pat. No. 6,193,155 to Walker et al.;

U.S. Pat. No. 6,282,522 to Davis et al.;

U.S. Pat. No. 6,289,324 to Kawan;

U.S. Pat. No. 6,295,522 to Boesch;

U.S. Pat. No. 6,299,062 to Hwang;

U.S. Pat. No. 6,375,084 to Stanford et al.; and

U.S. Pat. No. 6,402,038 to Stanford et al.

### OBJECT AND ADVANTAGES OF THE INVENTION

An advantage and object of the present invention is to provide a pre-paid credit card which can be used to make secure transactions online and over the internet. The system can be purchased using cash or a regular bank, credit or debit card, and the card may or may not have an expiration date. In a preferred embodiment, additional spending power, i.e., money or additional credit, can be added to the system by a telephone call, over the internet using regular credit or bank card or PayPal (™) or other similar payment method. Alternatively, money or spending power can be added to the system in person such as at convenience stores, at teller stations, automated card-charging stations, etc.

It is therefore an object and advantage of the present invention to provide a system for making secure transactions over the internet and a method and system which provide an alternate to using an existing credit card number for such transactions.

It is also a further object and advantage of the present invention to provide such system in which accidental loss due to carelessness or theft is limited to the remaining value on the card.

It is yet a still further object and advantage of the present invention to provide a system of the present invention which can be a source of revenue, i.e., incentives or pecuniary return in the form of commissions or rebates, etc., and the vending company or companies can sell the cards of the present invention and ship through the regular postal service or by courier.

### SUMMARY

The present invention is a pre-paid credit card which can be used to make secure transactions online and over the internet. The system can be purchased using cash or a regular bank, credit or debit card, and the card may or may not have an expiration date. In a preferred embodiment, additional spending power, i.e., money or additional credit, can be added to the system by a telephone call, over the internet using regular credit or bank card or PayPal (™) or other similar payment method. Alternatively, money or spending power can be added to the system in person such as at convenience stores, at teller stations, automated card-charging stations, etc.

The present invention is also a system for making secure transactions over the internet and a method and system which provide an alternate to using an existing credit card number for such transactions.

The present invention is also a system in which accidental loss due to carelessness or theft is limited to the remaining value on the card.

The present invention is also a system for deriving a source of revenue, i.e., incentives or pecuniary return in the form of commissions or rebates, etc., wherein a vending company or companies can sell the cards of the present invention and ship through the regular postal service or by courier.

Numerous other advantages and features of the present invention will become readily apparent from the following detailed description of the invention and the embodiments thereof, from the claims and from the accompanying drawings.

### BRIEF DESCRIPTION OF THE DRAWINGS

The DRAWING is a flowchart showing features, options and the method of use of preferred embodiments of the pre-paid internet credit card system of the present invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

Unless specifically indicated otherwise, all amounts given in the text and the examples which follow are understood to be modified by the term “about,” and those figures expressed in terms of percent (%) are understood to refer to weight percent, unless indicated otherwise.

The DRAWING is a flowchart showing features, options and the method of use of preferred embodiments of the pre-paid internet credit card system of the present invention. As shown in the DRAWING, a preferred embodiment of the pre-paid internet credit card system 100 of the present invention is created to make purchases over the internet 102. An aspect of the invention 100 is that is has a pre-established credit limit 104. This credit limit 104 is a function of the amount of money paid for the card 100. In a next step, the important feature of the card 100 of the present invention is demonstrated, i.e., customers can make purchased over the internet without the risk of their credit card number being stolen 106. In essence, the risk of loss is limited to the amount of the face-value of the card 100 or less if some of the value of the card 100 has been used by a user making a purchase over the internet 120. Thus, the card 100 can be sent through the mail without risk of loss.

In a preferred embodiment of the present invention, the credit card 100 is issued by a new, existing or novel credit card company 108. In a preferred embodiment, then the card 100 is actually created or manufactured 110. This can be done directly by the credit card company which issued 108 the card 100 or, most likely, by a third party under license or other arrangement. Therefore, in a further step, the card 100 is created or conformed to the specific and individual laws of the countries in which the card 100 is used 112.

Once the card 100 complies with local rules and laws 112, then the card 100 can be sold at grocery stores, convenience stores, pharmacies or other points of sale 114. In case the card 100 is ever sent via postal service or other courier, there is a limited risk, i.e., the card 100 has a limited, predetermined credit limit or value 104 and therefore the need for auxiliary insurance is lessened. In any event, providing widespread availability of the card 100 at a range of different points of sale 114 can provide broader usage of the card 100.

In a further step, the card 100 is activated by scratching a protective coating over the PIN 116 of the card 100. Activation 116 is necessary because it guarantees that the card 100 is still fully charged, i.e., at it's preset credit limit 104. A user can immediately identify when the card 100 has been tampered with because the step of scratching off the protective coating 116 cannot be reversed without sophisticated, coating or depositing technology not available to most consumers. Thus, the scratch-off tamper-proofing 108 ensures greater security for the card 100.

Activation 116 of the card 100 can be accomplished by a bank or credit card company or other issuing entity of the card 100 to download funds or otherwise activate the card 100 from a remote location.

In a preferred embodiment of the card 100, a user can reuse the card 100 by adding more money or credit 118 to the card 100. Adding more money or credit 118 to the card 100 essentially increases and/or prolongs the useful life of the card 100. Once the initial, preset credit limit 104 has been reached, the user can make the decision to increase the available credit or not. If so, the user is still able to limit exposure to risk of loss or theft of the card 100. Of course, only the holder of the card 100 can determine or make decisions as to which products will be purchased over the internet 120. If necessary, the user can add more funds 118 to the card 100 either on-line or at a kiosk or in a department store with an office therefor. The card 100 can also be recharged 118 via telephone. Thus, the card 100 has essentially unlimited utility and can be used essentially in perpetuity.

In a preferred embodiment, the card 100 will have the name of the company or institution that sells the card 100. The only information you will find under the bar code will be the pin or ID number and the expiration date. If the customer needs a personalized card he will have to request this ahead of time. When customer wants to add more money he can do so via internet, phone call or in person.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A pre-paid internet credit card system for making secured purchases over the internet without using personal or corporate credit cards, the system comprising:
a physical card portion, the card portion having a personal identification number (PIN) and expiration date associated therewith and imbedded therein, the physical card portion also having a removable material for temporarily blocking the PIN from optical view;
a predetermined initial credit value, the predetermined initial credit value associated with the PIN;
means for activating the card;
an available credit value, the available credit value based upon the amount of use of the card by a user such that as the more a user uses the card, the less the available credit value remaining on the card; and
means for increasing the available credit value of the card such that the card is useful for making desired purchases over the internet.

2. The prepaid internet credit card of claim 1 further comprising a magnetic strip in which the PIN is imbedded.

3. The prepaid internet credit card of claim 1 in which the card is activated via the internet.

4. The prepaid internet credit card of claim 1 in which the card is activated over the telephone.

5. The prepaid internet credit card of claim 1 in which the card is activated via the internet.

6. The prepaid internet credit card of claim 1 in which the means for increasing the available credit value comprises a central computer with access to the PIN.

7. The prepaid internet credit card of claim 6 in which the available credit value can be increased by payment of cash.

8. The prepaid internet credit card of claim 6 in which the available credit value can be increased by regular credit card payment.

9. The prepaid internet credit card of claim 6 in which the available credit value can be increased by electronic transfer of funds.

10. The prepaid internet credit card of claim 1 in which the removable material can be scratched off by a user upon purchase of the card.
